(19) United States
(12) Patent Application Publication
(10) Pub. No.: US 2020/0049612 A1
(43) Pub. Date: Feb. 13, 2020

(54) Airborne Particle Counting Method and Device

(71) Applicant: Foshan Sensicfusion Technology Co., LTD, Foshan (CN)

(72) Inventor: Chang Liu, Foshan (CN)

(21) Appl. No.: 16/057,999

(22) Filed: Aug. 8, 2018

(51) Int. Cl. G01N 15/14

(52) U.S. Cl. CPC G01N 15/14; G01N 2015/1486; G01N 2015/1493; G01N 15/1429

(57) ABSTRACT

The present invention discloses an airborne particle counting method which makes the laser beam and the fluid flow passage vertically intersected to generate scattered light. The resulting scattered light is collected by two scattered light collecting plates to two spatial directions simultaneously. The resulting electrical signals generated by these two plates are respectively amplified by different subsequent signal amplification circuits, with different amplification factors. Statistical analysis is performed on each amplified electrical signal and amplitude distribution to measure the peak topography of electrical signals of different intensity. The numbers of particles of different sizes are obtained through calculation. The present invention has simple structure and low cost, and can provide more comprehensive signal collection of the scattered light, being beneficial to realize the comprehensive statistics of airborne particles of different sizes, to improve the accuracy of the statistics of airborne particles of various sizes, and to eliminate the influence of airborne particle form and shape on counting. The present invention also provides an airborne particle counting device.

### TECHNICAL FIELD

The present invention relates to the field of air detection technology, and particularly relates to an airborne particle counting method and device.

### BACKGROUND

Measuring the presence, size and number of particles in the aerosol by light scattering is a common particle counting means. Light (i.e. laser) shines on the particles and produces scattering (e.g. Mie scattering), and the scattered light is detected by the photosensitive element in the space to find the presence of particles. Due to the wide range of particle size in the air sample (e.g. 1-10 μm), the intensity distribution of the scattered light varies significantly. According to the Mie scattering theory, if the size differs by ten times, the difference in light intensity will be up to 1,000,000 (10⁶) times. At present, no system can accurately calculate the size and quantity of all particles, especially when the air contains water molecules or when the gas contains a large amount of particles. Air pollutant detection can be performed with the weighing method and the optical scattering method, of which the latter applies to the qualitative and rapid analysis and is suitable for residential and portable occasions. Coming from different sources, the size of particles in air (aerosol) can range from 0.1 micron to tens of microns. In different occasions, such as a quarry in the north or a ceramic production base in the south, the particle size distribution may be different.

Since light scattering is weak, a photosensitive device of a light detector requires signal amplification. In the prior art, the signal amplification factor of a light detector is predetermined, and the noise bottom line (grounded) and the saturation upper limit (power supply or battery voltage) are limited. For most portable modern products, the saturation supply voltage is typically 3.7V. It is difficult to use a light detector to observe the entire range (as the difference in electrical signal strength is up to 1,000,000 times or more), thus it is not possible to correctly estimate the size of all suspended particles in aerosol. For example, when the particle size is large, the signals with large scattered signal intensity make up a large part, and the signal is easily level-saturated. A single electronic amplification system can cover only ten or twenty times of the voltage difference, and can only estimate the distribution of particle size and number over a narrow range of light intensity, resulting in very limited particle count and size estimation accuracy.

In addition, it is also difficult to determine whether it relates to particle size or particle shape/material with single luminosity observed from a fixed spatial location. These limitations result in incomplete detection means of existing equipment and inaccurate test results. For example, the existing equipment is unable to directly determine whether a particle is the PM2.5 size (i.e. the particle size is 2.5 μm).

### SUMMARY

The aim of the present invention is to provide an airborne particle counting method which can provide the signal and amplitude distribution, and comprehensively and accurately judge out the particle size, number and form.

For this, the present invention adopts the following technical solutions.

An airborne particle counting method is characterized as follows: It makes the laser beam and the fluid flow passage vertically intersected to generate scattered light; the resulting scattered light is collected by two scattered light collecting plates to two spatial directions simultaneously; the resulting electrical signals generated by these two plates are respectively amplified by different subsequent signal amplification circuits, with different amplification factors; statistical analysis is performed on each amplified electrical signal and amplitude distribution to measure the peak topography of electrical signals of different intensity; the numbers of particles of different sizes are obtained through calculation.

As a further description of the above solution, the two scattered light collecting plates are of uniform size and disposed in parallel on both sides of the fluid flow passage.

As a further description of the above solution, the amplification factor of each subsequent signal amplification circuit is adjusted so that the amplification factors of these two circuits are the same, and the influence of the particle shape on the particle size estimation is eliminated by calculation.

As a further description of the above solution, there are two measurement points where the irradiating lasers are different in wavelength.

As a further description of the above solution, there are two measurement points where the irradiating lasers are the same in wavelength. The flight velocity of particles is calculated based on the time difference of one particle passing these two measurement points.

The present invention also provides an airborne particle counting device, characterized as follows: It comprises a laser generator, a fluid flow passage, several scattered light collecting plates, subsequent signal amplification circuits, and signal processing circuits; the laser beam emitted by the laser generator intersects the fluid flow passage vertically; the scattered light collecting plates are disposed on both sides of the fluid flow passage; each corresponding scattered light collecting plate is equipped with a subsequent signal amplification circuit; the signal processing circuits are connected to the subsequent signal amplification circuits.

As a further description of the above solution, there is only one laser generator; two scattered light collecting plates are respectively disposed at two sides of the position where the laser beam intersects with the fluid flow passage.

As a further description of the above solution, there are two laser generators irradiating at different locations of the fluid flow passage; each position is equipped with two scattered light collecting plates which are disposed in parallel on both sides of the fluid flow passage.

As a further description of the above solution, the signals of these two laser generators may be the same or not.

As a further description of the above solution, each corresponding subsequent signal amplification circuit is equipped with a magnification adjustment device.

The present invention has the following advantages:

First, instead of using collecting lens, the present invention directly takes advantage of the scattered-light-spot-emitting scattered light received by the two scattered light collecting plates in different spatial directions, which can provide more comprehensive signal collection of the scattered light, being beneficial to realize the comprehensive statistics of airborne particles of different sizes, to improve the accuracy of the statistics of airborne particles of various sizes, and to eliminate the influence of airborne particle form and shape on counting. For example, the reference to this patent can facilitate the judgment on solid particles and large water molecules (e.g. water molecules of 1-10 μm in diameter). For another example, the reference to this patent can improve the judgment accuracy of the air quality index (AQI). (The accuracy of existing systems for high-density pollution has been reduced).

Second, for different scattered light collecting plates, different magnification factors can be adopted to accurately monitor the large vapour particles in the air, so that the humidity influence can be predicted and compensated better. The magnification factors in this system can also be adjusted and controlled during use, so that the adaptive sensitivity can be arranged in an intelligent and suitable way according to the airborne particle size distribution.

Third, the airborne particle counting device provided in the present invention does not need any collecting lens or various special photoelectric detectors, and boasts advantages including simple structure, small volume and low cost. Compared with the actual production, with a volume of about ⅓ of that of those similar products in the market, the airborne particle counting device provided in the present invention further improves the miniaturization degree of an airborne particle detection device and is low in price, which is extremely valuable for market application.

### BRIEF DESCRIPTION OF DRAWINGS

FIG. 1 shows a schematic diagram of the existing airborne particle counting method;

FIG. 2 shows an electrical signal amplification diagram of the existing airborne particle counting method;

FIG. 3 shows an electrical signal amplification diagram of the airborne particle counting method provided in the present invention;

FIG. 4 is a schematic diagram of the airborne particle counting device in the embodiment 5 of the present invention;

FIG. 5 is a structure diagram of the airborne particle counting device in the embodiment 5 of the present invention;

FIG. 6 is a section view of the A-A in FIG. 5.

FIG. 7 is a structure diagram of the airborne particle counting device in the embodiment 6 of the present invention;

FIG. 8 is a section view of the B-B in FIG. 7.

### DESCRIPTION OF DRAWING MARKS

1: Laser generator; 2: laser beam; 3: airborne particle; 4: photoelectric device; 5: electronic amplifier; 6: small signal; 7: large signal; 8: level; 9: fluid flow passage; 10: scattered light collecting plate; 11: subsequent signal amplification circuit; 12: signal processing circuit.

### DETAILED DESCRIPTION

In the description of the present invention, it should be noted that for the words of locality, i.e. the terms including “centre”, “lateral”, “longitudinal”, “length”, “width”, “thickness”, “above”, “below”, “in front of”, “behind”, “left”, “right”, “vertical”, “horizontal”, “top”, “bottom”, “inside”, “outside”, “clockwise” and “anticlockwise”, indicating the orientation and positional relationship are only based on the information shown in the drawings, and merely for convenience and simplification of description of the present invention, rather than indicating or implying that the device or element involved must have a special orientation or be constructed and operated in a particular orientation. That is to say, it is shall not be construed as the limit on the specific protection range of the present invention.

In addition, the terms (if any) of “first” and “second” are used for descriptive purposes only and are not to be construed as indicating or implying a relative importance or implicitly indicating the number of technical features. The feature with a determiner such as “first” or “second” may express or imply one or more features. In the description of the present invention, the term “at least”, unless otherwise explicitly defined, means one or more.

In the present invention, the terms (if any) “assemble”, “link” and “connect” are to be construed broadly, unless otherwise explicitly stated and defined. For example, these words may mean: permanent connection, detachable connection, integrated connection, mechanical connection, direct connection, connection through an intermediate medium or the inner connection between two elements. For those skilled in the art, the specific meanings of the above terms in the present invention can be understood on a case-by-case basis.

In the present invention, unless otherwise stated and defined, the first feature may include the direct contact between the first and the second features “above” or “below” the second feature, and may also include the indirect contact between the first and the second features through additional features between them. Moreover, if the first feature is “above”, “below” and “on” the second feature, it may means that the first feature is right above and above the second feature, or merely that the first feature is higher than the second one. If the first feature is “above”, “below” and “under” the second feature, it may means that the first feature is right below and below the second feature, or merely that the first feature is lower than the second one.

In the following, the specific embodiments of the present invention will be further described in combination with the drawings in the Specification to make the technical solutions of the present invention and the beneficial effects more explicit. The embodiments described below with reference to the drawings are intended to illustrate the present invention and are not to be construed as limitation.

### Embodiment 1

An airborne particle counting method makes the laser beam and the fluid flow passage vertically intersected to generate scattered light. The resulting scattered light is collected by two scattered light collecting plates to two spatial directions simultaneously. The resulting electrical signals generated by these two plates are respectively amplified by different subsequent signal amplification circuits, with different amplification factors. Statistical analysis is performed on each amplified electrical signal and amplitude distribution to measure the peak topography of electrical signals of different intensity. The numbers of particles of different sizes are obtained through calculation. The two scattered light collecting plates are of uniform size and disposed in parallel on both sides of the fluid flow passage.

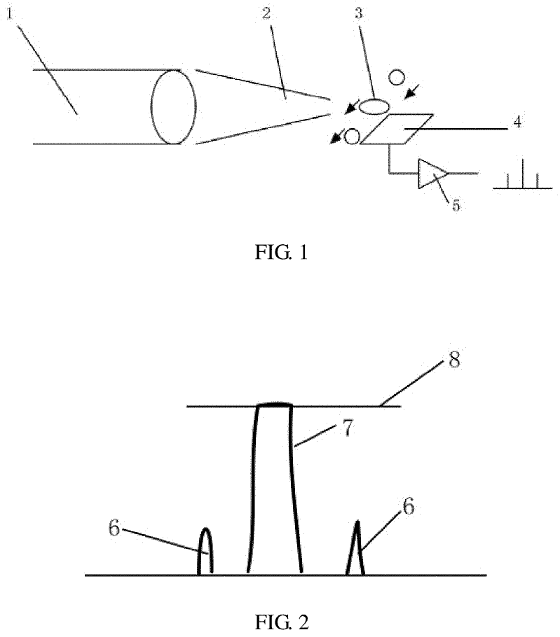

Since the optical signal, the electrical signal, and the concentrating device are on three axes respectively, we use a three-dimensional diagram to represent the relationship. As shown in FIG. 1, the laser beam 2 generated by the laser generator 1 reaches the airborne particles 3 in the focus point. The airborne particles here are intentionally identified by different sizes to distinguish them. We hereby select three typical airborne particles. When a photoelectric device 4 is used for light collection, the optical signal of this photoelectric device 4 is amplified by the electronic amplifier 5 to produce an output signal.

As shown in FIG. 2, in the output signal, when the electronic amplification factor is large, the small photoelectric signal 6 is amplified beyond the noise range, but the large signal 7 is saturated, and the saturated signal is limited by the level 8, so the specific size information of the signal is unknown.

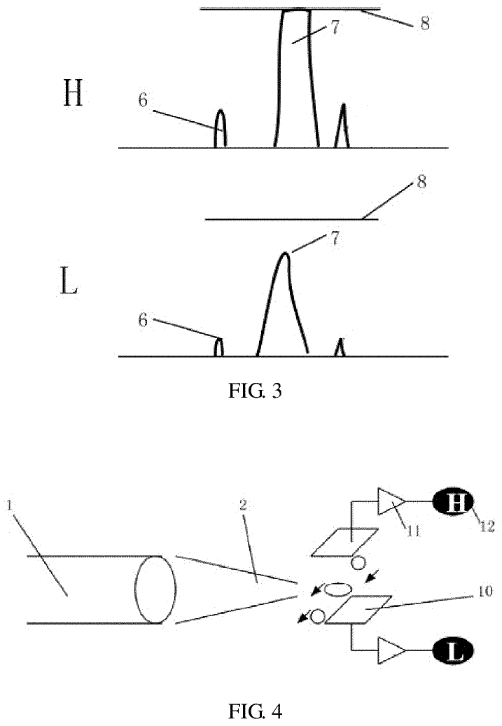

This embodiment adopts two scattered light collecting plates, of which the subsequent electronic amplification factors may be inconsistent. For example, one is high (H) while the other is low (L). Finally, two signal diagrams as shown in FIG. 3 are formed, where there are two electrical signals with different amplification factors. The combination of these two signals can make the peak topography of both the small and the large signals clear. Thus, more information about particles can be obtained for better judgment on the particle size and the physical form. For example, if the aerosol contains large water molecules (e.g. air humidifiers in the north), the signals of such molecules will be stronger. Due to premature signal saturation, the peak morphology is currently undetectable. However, this embodiment can solve this problem well, because such a system does not misidentify particles of large water molecules in the air as PM2.5 particles.

### Embodiment 2

The airborne particle counting method provided in this embodiment is basically the same as that in Embodiment 1. The difference is that the amplification factor of each subsequent signal amplification circuit is adjusted so that the amplification factors of the two subsequent signal amplification circuits are the same. In this way, the effect of particle shape on the particle size estimation is eliminated by calculation. In the case of the same amplification factors of the two light collectors, the light reception is doubled, which can reduce the energy output of the light source, decrease energy consumption and extend product life.

### Embodiment 3

The airborne particle counting method provided in this embodiment is basically the same as that in Embodiment 1. The difference is that there are two measurement points where the irradiating lasers are different in wavelength. Laser beams with two different wavelengths are used to achieve a comprehensive detection, so as to improve the accuracy of airborne particle size estimation.

### Embodiment 4

The airborne particle counting method provided in this embodiment is basically the same as that in Embodiment 1. The difference is that there are two measurement points where the irradiating lasers are the same in wavelength. The flight velocity of particles is calculated based on the time difference of one particle passing these two measurement points.

### Embodiment 5

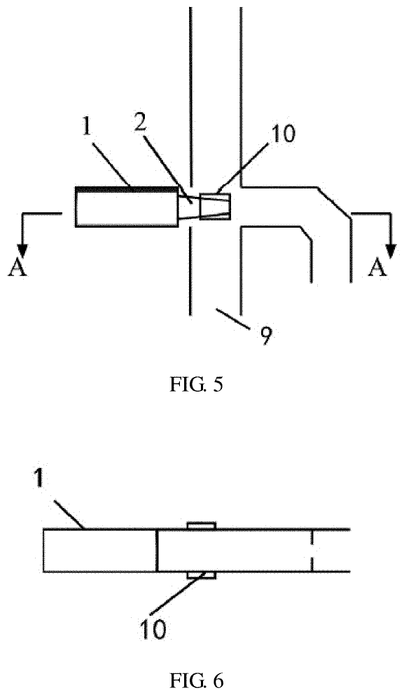

As shown in FIG. 4-FIG. 6, an airborne particle counting device, characterized as follows: It comprises a laser generator 1, a fluid flow passage 9, scattered light collecting plates 10, subsequent signal amplification circuits 11, and signal processing circuits 12; the laser beam 2 emitted by the laser generator 1 intersects the fluid flow passage 9 vertically; the scattered light collecting plates 10 are disposed on both sides of the fluid flow passage 9; each corresponding scattered light collecting plate 10 is equipped with a subsequent signal amplification circuit 11; the signal processing circuits 12 are connected to the subsequent signal amplification circuits 11.

In this embodiment, there is one laser generator 1; two scattered light collecting plates 10 are respectively disposed at two sides of the position where the laser beam 2 intersects with the fluid flow passage 9. Preferably, the two scattered light collecting plates 10 are arranged in parallel with each other to ensure the maximum receiving area. In other embodiments, the two scattered light collecting plates are not parallel, and are not limited to the embodiment.

The airborne particle counting device provided in this embodiment does not need any collecting lens or various special photoelectric detectors, and boasts advantages including simple structure, small volume and low cost. Compared with the actual production, with a volume of about ⅓ of that of those similar products in the market, the airborne particle counting device provided in this embodiment further improves the miniaturization degree of an airborne particle detection device and is low in price, which is extremely valuable for market application. In particular, for different scattered light collecting plates, different magnification factors can be adopted to provide more comprehensive signal collection of the scattered light, realize the comprehensive statistics of airborne particles of different sizes ranging from 1 μm to 10 μm, and accurately monitor the large vapour particles in the air, so that the humidity influence can be predicted and compensated better.

### Embodiment 6

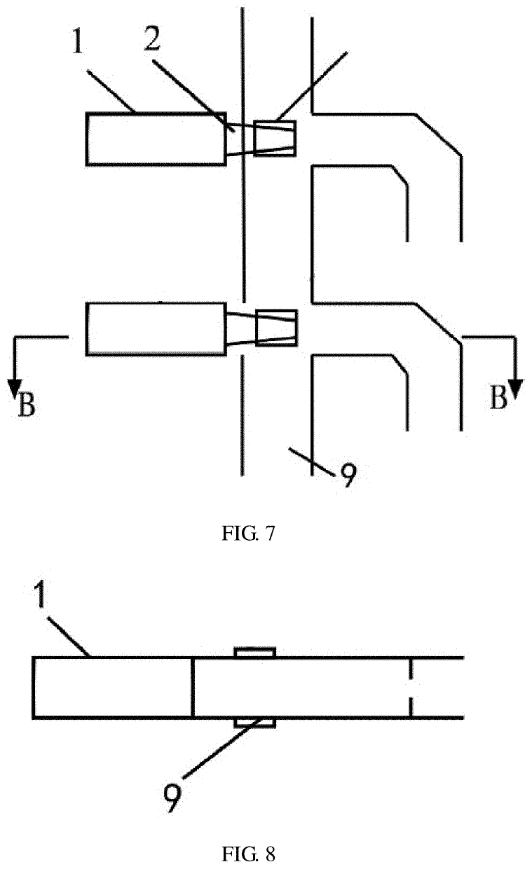

As shown in FIG. 7 and FIG. 8, the structure of the airborne particle counting device provided in this embodiment is basically the same as that in Embodiment 5. The difference is that there are two laser generators 1 respectively disposed on the upstream and downstream of the fluid flow passage 9. For the scattered light spots generated by each laser generator 1, two scattered light collecting plates 10 are provided respectively. Two scattered light collecting plates 10 are disposed on both sides of the fluid flow passage 9 in parallel. Corresponding signal amplification circuits 11 are respectively provided for each scattered light collecting plate 10.

The signals of the two laser generators may be the same or not, so may the wavelengths emitted by the two laser generators 1 and the corresponding amplification factors of each signal amplification circuit; they should be set according to the user's actual needs.

### Embodiment 7

The structure of the airborne particle counting device provided in this embodiment is basically the same as that in Embodiment 5. The difference is that each corresponding subsequent signal amplification circuit is equipped with a magnification adjustment device, so that the amplification factor can be adjusted according to actual needs.

Through the above description of the structure and principle, those skilled in the art should understand that the present invention is not limited to the forgoing detailed description. The modifications and substitutions of the present invention are based on the present invention, and the scope of the invention is defined by the claims and their equivalents. The undescribed parts in the detailed description are prior art or common knowledge.

1. An airborne particle counting method, characterized in that it makes the laser beam and the fluid flow passage vertically intersected to generate scattered light; the resulting scattered light is collected by two scattered light collecting plates to two spatial directions simultaneously; the resulting electrical signals generated by these two plates are respectively amplified by different subsequent signal amplification circuits, with different amplification factors; statistical analysis is performed on each amplified electrical signal and amplitude distribution to measure the peak topography of electrical signals of different intensity; the numbers of particles of different sizes are obtained through calculation.

2. An airborne particle counting method in claim 1, characterized in that the two scattered light collecting plates are of uniform size and disposed in parallel on both sides of the fluid flow passage.

3. An airborne particle counting method in claim 1, characterized in that the amplification factor of each subsequent signal amplification circuit is adjusted so that the amplification factors of these two circuits are the same, and the influence of the particle shape on the particle size estimation is eliminated by calculation.

4. An airborne particle counting method in claim 1, characterized in that there are two measurement points where the irradiating lasers are different in wavelength.

5. An airborne particle counting method in claim 1, characterized in that there are two measurement points where the irradiating lasers are the same in wavelength. The flight velocity of particles is calculated based on the time difference of one particle passing these two measurement points.

6. An airborne particle counting device, characterized in that it comprises a laser generator, a fluid flow passage, several scattered light collecting plates, subsequent signal amplification circuits, and signal processing circuits; the laser beam emitted by the laser generator intersects the fluid flow passage vertically; the scattered light collecting plates are disposed on both sides of the fluid flow passage; each corresponding scattered light collecting plate is equipped with a subsequent signal amplification circuit; the signal processing circuits are connected to the subsequent signal amplification circuits.

7. An airborne particle counting device in claim 6, characterized in that there is one laser generator; two scattered light collecting plates are respectively disposed at two sides of the position where the laser beam intersects with the fluid flow passage.

8. An airborne particle counting device in claim 6, characterized in that there are two laser generators irradiating at different locations of the fluid flow passage; each position is equipped with two scattered light collecting plates which are disposed in parallel on both sides of the fluid flow passage.

9. An airborne particle counting device in claim 8, characterized in that the signals of these two laser generators may be the same or not.

10. An airborne particle counting device in claim 6, characterized in that each corresponding subsequent signal amplification circuit is equipped with a magnification adjustment device.
